(19) United States
(12) Patent Application Publication
(10) Pub. No.: US 2002/0064491 A1
(43) Pub. Date: May 30, 2002

(54) Method for increasing the long-term stability of exhaust system catalysts

(75) Inventors: Peter Muller, Munchen (DE); Stefan Detterbeck, Munchen (DE); Hans Schafer, Munchen (DE); John K. Hochmuth, Bridgewater, NJ (US)

Correspondence Address: Chief Patent Counsel, Engelhard Corporation, 101 Wood Avenue, P. O. Box 770, Iselin, NJ, 08830-0770, US

(73) Assignee: Engelhard Corporation, Iselin, NJ (US)

(21) Appl. No.: 10/027,977

(22) Filed: Dec. 20, 2001

Related U.S. Application Data
(63) Continuation of application No. 09/156,697, filed on Sep. 18, 1998, now abandoned.

(30) Foreign Application Priority Data
Sep. 19, 1997 (DE) 197 41 315.3

(51) Int. Cl. B01D 53/34

(52) U.S. Cl. 423/210; 95/116

(57) ABSTRACT

In order to increase the long-term stability of the exhaust catalyst of an internal combustion engine, the exhaust gas is purified with respect to volatile phosphorus compounds before entering the catalyst.

The invention relates to a method and to a device of increasing the long-term stability of components of an exhaust system, in particular, catalysts for purifying the exhaust gases of internal combustion engines.

In order to purify the exhaust gases of a motor vehicle with respect to carbon monoxide (CO), hydrocarbon (HC) and nitrogen oxide (NOₓ), use is currently made of customarily controlled 3-way catalysts, in which case the way that the injection system forms the mixture is adjusted using a lambda probe and a controller so that the composition of the exhaust gas permits optimum simultaneous conversion of CO, HC and NOₓ at the most favorable operating point of the catalyst. A catalyst of this type has, for example, a ceramic or metal support with an aluminum oxide coating, which is impregnated with a noble metal such as platinum.

The fuel consumption of diesel engines is reduced if they can be operated with a lean mixture (air excess). However, 3-way catalysts are not suitable for purifying exhaust gases in this case. Special NOₓ catalysts have therefore been developed for lean-burn diesel engines, including so-called NOₓ storage catalysts, which have, on a ceramic or metal support, an aluminium oxide coating that contains, on the one hand, metals such as alkali, alkaline earth or rare earth metals, which absorb NOₓ, and on the other hand, noble metals such as platinum. In the case of a lean, that is to say oxygen-rich exhaust gas, NOₓ, for example, is absorbed by the alkaline earth metal, while CO and HC, for example, are oxidized by the platinum to form carbon dioxide and water. Through intermittent temporary rich-burn operation, the NOₓ absorbed on the catalyst is reduced to nitrogen by the reducing gases, such as HC, in the rich, i.e. low-oxygen, exhaust gas and the catalyst is thereby regenerated (cf. U.S. Pat. No. 5,575,983, EP 0 657 204 A1).

It is known that sulfur oxides, which can be formed by the sulfur contained in the fuel, lead to deactivation of an NOₓ storage catalyst. This so-called sulfatizing of the catalyst can be counteracted by exposing the catalyst to hot rich exhaust gas, resulting in the formation of hydrogen sulfide (cf. U.S. Pat. No. 5,575.,983; DE 29 07 106 C2). Rich-burn operating states are, however, associated with increased fuel consumption. If they are not encountered during normal operation, they will further need to be generated, for example by altering the ignition timing and lambda.

In spite of such measures, the long-term stability of the exhaust catalysts for motor vehicles, in particular NOₓ (storage) catalysts for lean-burn diesel engines, still leaves something to be desired.

The object of the invention is therefore to significantly increase the long-term stability of components of an exhaust system, in particular exhaust catalysts, in particular for NOₓ (storage) catalysts for motor vehicles.

This is achieved according to the invention with the method presented in claim 1. Claims 2 to 5 give advantageous embodiments of the method according the invention. FIG. 6 specifies a preferred device for carrying out the method according to the invention.

It has unexpectedly been established that traces of phosphorus compounds contained in the exhaust gas lead over time to considerable deactivation, in particular, of an NOₓ storage catalyst. These phosphorus compounds probably originate primarily from the engine oil, which generally contains phosphorus compounds for improving anti-wear properties. Certain fuel grades may also sometimes contain small quantities of phosphorus compounds.

The irreversible deactivation of the exhaust catalysts of internal combustion engines was demonstrated by the following tests:

A diesel engine with a (very high) oil consumption of 0.5 liters per 8 hours was driven for 40 hours (5×80 hours) in lean-burn with intermittent rich-burn, specifically one minute of lean (lambda about 1.3) and from 1 to 2 seconds of rich (lambda about 0.8) in alternation. The exhaust gases of the engine were fed to a conventional NOₓ storage catalyst.

The CO, HC and NOₓ content in the exhaust gas leaving the catalyst was measured continuously. The first measurement was taken about 2 hours after starting to use the engine, and therefore also the catalyst. It was found that the NOₓ conversion ratio after 40 hours was still only 40% of the conversion ratio which was measured 2 hours after the engine started to be used. Sulfatizing could be ruled out. Chemical and physical analyses of the catalyst showed considerable phosphorus enrichment in the inflow region.

This phosphorus enrichment in the catalyst can be prevented, and the long-term stability of the catalyst can therefore be substantially improved, if volatile phosphorus compounds are removed from the exhaust gas before it enters the catalyst.

To do this, a stationary device is arranged, preferably, in the exhaust pipe between the engine and the catalyst, which device is capable of removing phosphorus from the exhaust gas and binding it, so that only an exhaust gas flow which is purified with respect to phosphorus or phosphorus compounds reaches the NOₓ storage catalyst. One suitable example for this is an absorber which contains an absorbent for absorbing the volatile phosphorus compounds under the operating conditions, in other words, in particular the temperature of the exhaust gases, which may, between the engine and the catalyst, be between ambient temperature and about 1000° C.

In the exhaust gas, the phosphorus is primarily present as phosphorus oxide. Accordingly, suitable metals and metal compounds are, in particular, ones which, under the stated temperature conditions, form salts, that is to say non-volatile solid compounds, with phosphorus oxide, to be specific salts which are stable up to 600° C., preferably up to 1000° C. or more, and thus do not decompose again at high temperatures to form volatile phosphorus compounds.

Almost all metals per se are capable of this, in particular the metals in groups 1A (for example Li, Na, K), 1B (for example Cu, Ag), 2A( for example Mg,Ca), 2B (for example Zn) or 3A (for example Al,Y, including the rare earth metals) of the Periodic Table, which form metal phosphates with phosphorus oxide; and additionally metals which, like molybdenum form complex phosphates with phosphorus.

For reasons of cost and environmental considerations, however, use is made in particular of alkaline earth metals, especially calcium, for example in the form of carbonates, in order to convert the volatile phosphorus compounds contained in the exhaust gas into insoluble, non-volatile, solid phosphates, for example into calcium phosphate.

The invention is suitable not only for NOₓ storage catalysts, but also for NOₓ catalysts which operate on the basis of different principles than NOₓ storage catalysts.

It can, however, also be employed for other components of exhaust systems, and is thus suitable for exhaust systems with controlled 3-way catalysts if components, for example sensors, which are exposed to the exhaust gas but are not compatible with phosphorus, are present the exhaust pipe.

The absorber according to the invention for absorbing the volatile phosphorus compounds in the exhaust gas may, for example, consist of a metal or ceramic support, such as cordierite, for example in plaited form, with a honeycomb structure, in a spiral or the like, the support being coated with a metal or metal compound which, as specified above, is capable of chemically binding the volatile phosphorus compounds contained in the exhaust gas. The absorber could also consist directly of the corresponding metal or metal compound.

The absorber may in this case be arranged in a separate housing between the engine and the catalyst. It may, however, also be provided immediately at the gas inlet region of the catalyst, inside the catalyst housing.

The absorber may be designed in such a way that its capacity for absorbing the volatile phosphorus compounds in the exhaust gas is sufficient during the life of a motor vehicle.

It is also conceivable for such a metal or such a metal compound which leads to the formation of salts, i.e. solid phosphorus compounds in the exhaust gas, to be added to or metered into the engine oil and/or the fuel, or separately into the exhaust pipe, so that fine inert solid particles, which pass unstopped through the entire exhaust system, are thus formed from the volatile phosphorus compounds. Unexpectedly, this has not, however, been achieved sufficiently with the concentrations of calcium and/or calcium compounds known in contemporary engine oil. The probable reason for this is that, in the case of engines which operate with lean fuel mixtures the affinity of the storage catalyst material for phosphorus is higher than that of calcium or the calcium compound for phosphorus.

1. A method of increasing the long-term stability of components of an exhaust system, in particular, catalysts for purifying the exhaust gases of internal combustion engines, wherein the exhaust gas is purified with respect to volatile phosphorus compounds before contact with the components or before entering the catalyst.

2. The method as claimed in claim 1, wherein the volatile phosphorus compounds in the exhaust gas are removed by reactions with metals or metal compounds which form solid metal-phosphorus compounds with the volatile phosphorus compounds.

3. The method as claimed in claim 2, wherein calcium or a calcium compound is used as the metal or metal compound.

4. The method as claimed in claim 2 or 3, wherein the metal or metal compound for conversion with the volatile phosphorus compound is metered into the exhaust gas upstream of the catalyst.

5. The method as claimed in claim 2, wherein a metal or a metal compound, which leads to the formation of a solid metal-phosphorus compound in the exhaust gas, is added to the engine oil and/or to the fuel of the internal combustion engine.

6. A device for carrying out the method as claimed in claims 1 to 3, having an absorber for absorbing the volatile phosphorus compounds before the exhaust gas enters the catalyst.
